(19) United States
(12) Patent Application Publication
(10) Pub. No.: US 2024/0049646 A1
(43) Pub. Date: Feb. 15, 2024

(54) SYSTEMS, METHODS, AND DEVICES FOR HARVESTING PLANTS WITH AN ULTRASONIC BLADE

(71) Applicant: BOWERY FARMING, NEW YORK, NY (US)

(72) Inventors: Charles Sanford Smyth Goodwin, New York, NY (US); Gregory DiLuzio, New York, NY (US); Theodore Irving Goodman, New York, NY (US)

(73) Assignee: BOWERY FARMING, NEW YORK, NY (US)

(21) Appl. No.: 18/365,651

(22) Filed: Aug. 4, 2023

Related U.S. Application Data
(60) Provisional application No. 63/396,341, filed on Aug. 9, 2022.

(51) Int. Cl. A01G 3/00; A01G 22/15; B26D 7/08; B26D 1/06; B26D 7/01; B26D 7/18

(52) U.S. Cl. CPC A01G 3/00; A01G 22/15; B26D 7/086; B26D 1/065; B26D 7/01; B26D 7/18

(57) ABSTRACT

Systems, methods and devices for harvesting plants include an ultrasonic blade for severing top portion(s) of one or more plants. The system includes a first conveyor surface which moves the one or more plants in a linear direction. The ultrasonic blade is disposed above the first conveyor surface at an end of a second conveyor surface of a retrieval system. A first top portion of the one or more plants is severed by contacting a first plant at a first height with the ultrasonic blade. Also, the height of the ultrasonic blade can be adjusted such that a second top portion of the one or more plants is severed by contacting a second plant at a second height with the ultrasonic blade. Furthermore, the ultrasonic blade can have an edge which vibrates at a frequency of 20 kHz or greater to severe the top portion(s).

### CROSS-REFERENCE TO RELATED APPLICATION

This application claims priority to U.S. Provisional patent application Ser. No. 63/396,341 filed Aug. 9, 2022 and titled “SYSTEMS, METHODS, AND DEVICES FOR HARVESTING PLANTS WITH AN ULTRASONIC BLADE,” the entirety of which is incorporated herein by reference.

### BACKGROUND

Typical plant cutting systems used to harvest plants frequently damage or bruise the salable portion of the plant, achieve inconsistent results, and/or are inefficient. Moreover, due to variations in different types of plants, a technique for harvesting one type of plant may be less effective for harvesting another type of plant, creating additional inconsistencies and inefficiencies. It is with these observations in mind that the presently disclosed technology was conceived.

It is with these observations in mind, among others, that various aspects of the present disclosure were conceived and developed.

### BRIEF SUMMARY

The presently disclosed technology addresses the foregoing problems by providing systems, methods and devices to harvest plants. For example, a system for harvesting plants can include a first conveyor surface for moving one or more plants in a linear direction; and/or an ultrasonic blade disposed above the first conveyor surface at an end of a second conveyor surface of a retrieval system. The retrieval system can be positioned at least partially above the first conveyor surface for receiving a top portion of the one or more plants cut by the ultrasonic blade. Additionally, the first conveyor surface can be an infeed conveyor belt; the second conveyor surface can be an inclined conveyor belt; and/or the retrieval system can include a conveyor mounting frame positioning the inclined conveyor belt above the infeed conveyor belt.

In some examples, the conveyor mounting frame can includes an angle or height adjuster for adjusting an angle or height of the inclined conveyor belt relative to the infeed conveyor belt. The height of the inclined conveyor belt can be adjustable between a first height and a second height, the first height corresponding to a first type of the one or more plants and the second height corresponding to a second type of the one or more plants. Additionally, the ultrasonic blade can be coupled to an underside of the inclined conveyor belt. A blade angle formed by the ultrasonic blade and the infeed conveyor belt can be adjustable to correspond to a type or a maturity of the one or more plants. Moreover, the one or more plants can include a plurality of edible plants in a growing tray on the first conveyor surface.

In some instances, the ultrasonic blade includes a row of ultrasonic blades extending perpendicular to the linear direction in which the one or more plants move. Also, a cutting edge of the ultrasonic blade can be directed in a third direction that forms an acute angle with a plane defined by the first conveyor surface. Furthermore, the ultrasonic blade can include a honed edge that contacts one or more stems of the one or more plants. The ultrasonic blade can also form a non-perpendicular cutting angle with one or more stems of the one or more plants.

In some examples, a method for harvesting plants includes moving one or more plants held by a plant holder in a linear direction using an infeed conveyor belt; cutting the one or more plants with an ultrasonic blade disposed above the infeed conveyor belt to separate a top portion of the one or more plants; and/or retrieving the top portion of the one or more plants in a retrieval system disposed at least partly above the infeed conveyor belt. The method can also include moving, using the infeed conveyor belt a bottom portion of the one or more plants cut by the ultrasonic blade underneath the retrieval system. Retrieving the top portion of the one or more plants can include receiving the top portion of the one or more plants on an inclined conveyor belt of the retrieval system positioned above the infeed conveyor belt. Furthermore, retrieving the top portion of the one or more plants can include dropping the top portion of the one or more plants off an end of the inclined conveyor belt into a collection area, such as a collection bin, directly into a hopper, or into another machine's intake.

In some instances, retrieving the top portion of the one or more plants includes sending the top portion of the one or more plants from the inclined conveyor belt onto a takeaway conveyor belt. Additionally, the one or more plants can include a first one or more plants, and cutting the first one or more plants can include contacting the first one or more plants with the ultrasonic blade at a first cutting angle. Also, the method can further include adjusting a position of the ultrasonic blade relative to the infeed conveyor belt; and/or cutting a second one or more plants by contacting the second one or more plants with the ultrasonic blade at a second cutting angle that is different than the first cutting angle. Moreover, the first cutting angle can correspond to a first height associated with the first one or more plants and the second cutting angle corresponds to a second height associated with the second one or more plants. Cutting the one or more plants can include severing one or more stems of one or more plants with an edge of the ultrasonic blade vibrating at a frequency of 20 kHz or greater.

In some examples, a method for harvesting plants can include moving a first plant in a linear direction using an infeed conveyor belt; separating a first top portion of the first plant using an ultrasonic blade by contacting a first portion of the first plant at a first height with the ultrasonic blade; and/or retrieving the first top portion of the first plant with a retrieval system. The method can also include adjusting a height of the ultrasonic blade; moving a second plant in the linear direction using the infeed conveyor belt; and/or separating a second top portion of the second plant using the ultrasonic blade by contacting a second portion of the second plant at a second height with the ultrasonic blade. The second height can be a different than the first height. Also, the method can include retrieving the second top portion of the second plant with the retrieval system.

The foregoing is intended to be illustrative and is not meant in a limiting sense. Many features of the embodiments may be employed with or without reference to other features of any of the embodiments. Additional aspects, advantages, and/or utilities of the presently disclosed technology will be set forth in part in the description that follows and, in part, will be apparent from the description, or may be learned by practice of the presently disclosed technology.

### BRIEF DESCRIPTION OF THE DRAWINGS

The following detailed description will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate implementations of systems, methods, and devices consistent with the disclosed subject matter and, together with the description, serves to explain advantages and principles consistent with the disclosed subject matter, in which:

FIG. 1 illustrates an example system for harvesting one or more plants with an ultrasonic blade;

FIG. 2. illustrates an example system for harvesting one or more plants with an ultrasonic blade having an adjustable cutting angle, which can form at least a portion of the system depicted in FIG. 1;

FIG. 3 illustrates an example method for harvesting one or more plants, which can be performed by the system depicted in FIG. 1;

FIG. 4 illustrates an example method for harvesting one or more plants, which can be performed by the system depicted in FIG. 1;

FIGS. 5A-5C illustrate an example system for harvesting one or more plants with an ultrasonic blade with different configurations, which can form at least a portion of the system depicted in FIG. 1; and

FIGS. 6A and 6B illustrate an example system for harvesting one more plants having an operational configuration and a maintenance configuration, which can form at least a portion of the system depicted in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “above,” “below,” “up,” and “side,” are used in the description for clarity in specific reference to the figures and are not intended to limit the scope of the presently disclosed technology or the appended claims. Further, it should be understood that any one of the features of the presently disclosed technology may be used separately or in combination with other features. Other systems, methods, features, and advantages of the presently disclosed technology will be, or become, apparent to one with skill in the art upon examination of the figures and the detailed description. It is intended that all such additional systems, methods, features, and advantages be included within this description, be within the scope of the presently disclosed technology, and be protected by the accompanying claims.

Further, as the presently disclosed technology is susceptible to embodiments of many different forms, it is intended that the present disclosure be considered as an example of the principles of the presently disclosed technology and not intended to limit the presently disclosed technology to the specific embodiments shown and described. Any one of the features of the presently disclosed technology may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments, but is not necessarily included. Thus, the presently disclosed technology may include a variety of combinations and/or integrations of the embodiments described herein. Additionally, all aspects of the present disclosure, as described herein, are not essential for its practice. Likewise, other systems, methods, features, and advantages of the presently disclosed technology will be, or become, apparent to one with skill in the art upon examination of the figures and the description. It is intended that all such additional systems, methods, features, and advantages be included within this description, be within the scope of the presently disclosed technology, and be encompassed by the claims.

Any term of degree such as, but not limited to, “substantially,” as used in the description and the appended claims, should be understood to include an exact, or a similar, but not exact configuration. For example, “a substantially planar surface” means having an exact planar surface or a similar, but not exact planar surface. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

The term “coupled” is defined as connected, whether directly or indirectly through intervening components, and is not necessarily limited to physical connections. The connection can be such that the objects are permanently connected or releasably connected. The terms “comprising,” “including” and “having” are used interchangeably in this disclosure. The terms “comprising,” “including” and “having” mean to include, but not necessarily be limited to the things so described. The term “real-time” or “real time” means substantially instantaneously.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

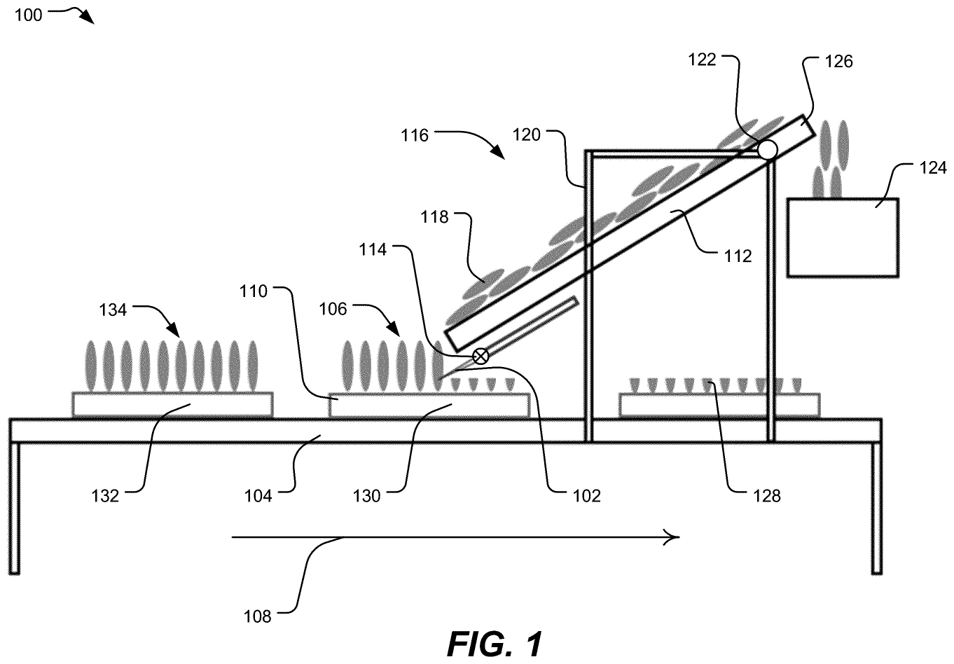

FIG. 1 illustrates an example system 100 for harvesting plants using an ultrasonic blade 102. The system 100 can include a conveyor surface, such as an infeed conveyor belt 104 of a plant harvesting assembly line (e.g., of a farming, harvesting, and/or packaging facility). The infeed conveyor belt 104 can move one or more plant(s) 106 in a linear direction 108 (e.g., a first direction) towards the ultrasonic blade 102. The plant(s) 106 can include edible plants (e.g., leafy greens, lettuce, basil, mint, sprouts, other vegetables, herbs, and/or fruits) positioned in a plant holder 110, raft, growing tray, or receptacle that holds the plant(s) 106 in an upright position. The plant(s) 106 may be grown in any environment, such as an outdoor growing area (e.g., a garden or a farm) or an indoor farming facility, such as a hydroponic or aeroponic growing system.

In some examples, the ultrasonic blade 102 is disposed above the infeed conveyor belt 104 attached to a bottom end and/or underside of another conveyor surface, such as an inclined conveyor belt 112. The ultrasonic blade 102 can include one or more ultrasonic blades 102, such as a row of ultrasonic blades 102, and/or a flat ultrasonic blade edge, which extends in a second direction (e.g., direction 114 shown in FIG. 1 directed into the page) non-parallel or perpendicular to the linear direction 108 in which the plant(s) 106 are moved. The ultrasonic blade 102 can be arranged to form a precise cutting angle directed to the oncoming plant(s) 106. Additionally or alternatively, the ultrasonic blade(s) 102 can be mounted to one or more robotic arms to provide targeted cutting, for instance, for harvesting fruit that is not uniform in height or to preserve plant structures that will continue to grow post-harvest. In these scenarios, the conveyor belt 112 may also stop or pause at a set position (e.g., a cutting position), the robotic arm(s) can move to the proper cutting location and cut the plant(s) 106, and then the conveyor belt can continue moving after the plant(s) 106 are cut. Once the plant(s) 106 contact the ultrasonic blade 102 and are cut by the ultrasonic blade 102 a retrieval system 116 positioned at least partially above the infeed conveyor belt 104 can receive a top portion 118 severed from the plant(s) 106. As such, the plant(s) 106 can be harvested with improved efficiency and reduced bruising compared to previous techniques.

For instance, the retrieval system 116 can include a conveyor mounting frame 120 coupling the inclined conveyor belt 112 to the infeed conveyor belt 104 (e.g., or another component of the system 100 disposed above the infeed conveyor belt 104). The conveyor mounting frame 120 can position the inclined conveyor belt 112 over the infeed conveyor belt 104 with a gap between the inclined conveyor belt 112 and the infeed conveyor belt 104).

In some examples, the conveyor mounting frame 120 can include an angle adjuster 122 (e.g., an adjustable screw, slide bolt, and/or lockable hinge) for adjusting an angle of the conveyor mounting frame 120 and/or the ultrasonic blade 102. The conveyor mounting frame 120 can include multiple angle adjusters 122 forming multiple attachment points to the inclined conveyor belt 112, such as a first angle adjuster 122 at first corner or first leg of the conveyor mounting frame 120 and a second angle adjuster 122 at a second corner or second leg of the conveyor mounting frame 120. Moreover, one or more angle adjuster 122 can be coupled to the ultrasonic blade 102 for adjusting an angle of the ultrasonic blade 102 with respect to the inclined conveyor belt 112. The angle adjuster 122 can be adjusted automatically using an electrical actuator, for instance, to match a certain type of plant or different species of the same plant. As such, the angle and/or height of the ultrasonic blade 102 above the infeed conveyor belt 104 and/or the plant(s) 106 (e.g., the stems of the plant(s) 106) can be precisely controlled and adjusted with a high level of granularity and reduced error. The system 100 can use the ultrasonic blade 102 to improve a quality of the cut and reduce product loss in the transition to the inclined conveyor belt 112. As such, in some scenarios, the system 100 improves yield and reduces labor costs using the techniques disclosed herein.

In some instances, the retrieval system 116 includes a collection bin 124 disposed at or below a second end 126 of the inclined conveyor belt 112 to catch the top portion(s) 118 of the plant(s) 106 falling off the second end 126. Additionally or alternatively, at least some of the top portion(s) 118 can be sent from the second end 126 to another conveyor belt, such as a side conveyor belt, a takeaway conveyor belt, another inclined or declined conveyor belt, a horizontal conveyor belt, or so forth. As such, the top portion(s) 118 can be transported away from the cutting arrangement of the system 100 to another processing facility unit (e.g., for cleaning, weighing, packaging, combinations thereof, etc.). A bottom portion 128 of the plant(s) 106, which can include a root plug or stem of the plant(s) 106, can continue in the linear direction 108, through the gap formed by the inclined conveyor belt 112, and underneath the inclined conveyor belt 112 and/or the conveyor mounting frame 120. The harvested raft holding the bottom portion 128 can continue along the infeed conveyor belt 104 towards an exit where it can be transferred to downstream processing equipment, such as a weighing unit or disposal unit.

In some examples, a raft holding the harvested bottom portion 128 of the plant(s) 106 is kept in the plant holder 110 (e.g., a tray, table, or bench), and the raft is removed from the tray after harvesting to be moved to a deplug/cleaning area. As such, an entire tray can run through the system 100 to be harvested as one large raft. In some examples, the harvested raft with the bottom portion 128 can be sent back into a growing area for a second or third growth phase prior to being harvested again. In some arrangements, the harvested raft could go through a second harvesting system, where the first harvesting system removes the leaves portion of the plant(s) 106 for primary packaging, the second harvester removes the stems which can go into secondary packaging (e.g., for animal feed or composting) so that only the roots and grow media are sent to waste.

Furthermore, in some examples, multiple different types of plants 106 can be cut and harvested by the system 100. For instance, a first raft 130 can hold first plant(s) 106, and a second raft 132, can hold second plant(s) 134. The second plant(s) 134 can be a different type of plant than the first plant(s) 106, as discussed in greater detail below. The second raft 132 holding the different type of plant 134 can follow the first raft 130 on the infeed conveyor belt 104 for streamlined harvesting of multiple different types of plants.

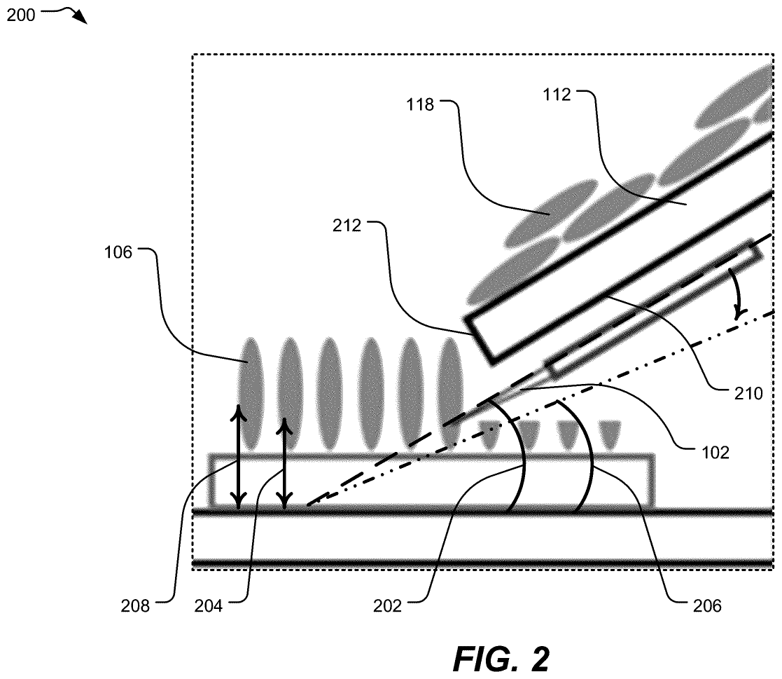

FIG. 2 illustrates an example system 200 for harvesting plant(s) 106 with the ultrasonic blade 102, which can form at least a portion of the system 100 depicted in FIG. 1. As depicted in FIG. 2, the ultrasonic blade 102 can be adjusted and secured in place to form multiple different cutting angle and/or cutting heights.

For instance, the ultrasonic blade 102 can form a first cutting angle 202 and/or a first height 204. The first cutting angle 202 and/or the first height 204 can correspond to a first type of plant associated with the first plant(s) 106 (e.g., a particular species of lettuce), such that a cutting edge of the ultrasonic blade 102 contacts a target area on the stem of the plant(s) 106 with a high degree of accuracy. The position of the ultrasonic blade 102 and/or the inclined conveyor belt 112 relative to the infeed conveyor belt 104 can be adjusted, using the angle adjuster 122 on the conveyor mounting frame 120, to form a second cutting angle 206 and/or position the cutting edge of the ultrasonic blade 102 at a second height 208. The second cutting angle 206 and/or the second height 208 can correspond to a second type of plant associated with the second plant(s) 134. For instance, the second plant(s) 134 may be a different species of the same type of vegetable as the first plant(s) 106 (e.g., a different species of lettuce), or the second plant(s) 134 can be a different type of vegetable or plant altogether (e.g., sprouts, basil, etc.). Additionally or alternatively, the second cutting angle 206 and/or the second height 208 can correspond to a maturity of the second plant(s) 134 that is different from the first plant(s) 106, such as a plant at different growth stages. The ultrasonic blade 102 can be adjusted to any number of different angles and heights to correspond to any plant characteristic that causes a different cutting area of the plant stem to be targeted. A range of heights for the ultrasonic blade 102 can be between 0″ and 6″ above the top of the grow media, for instance, for a leafy green type of plant. The first cutting angle 202 and/or the second cutting angle 206 can be acute angle(s) relative a horizontal plane defined by the infeed conveyor belt 104 and/or a top of the plant holder 110 such that the ultrasonic blade 102 contacts the plant(s) 106 non-perpendicularly relative to a vertical axis of the plant(s) 106. Additionally or alternatively, the first cutting angle 202 and/or the second cutting angle 206 can be parallel to the horizontal plane such that the ultrasonic blade 102 contacts the plant(s) 106 substantially perpendicular to the vertical axis of the plant(s) 106. These orientations can depend on a type, shape, and/or maturity of the plant(s) 106 to provide a cleanest and/or fastest cut with the ultrasonic blade 102.

In some instances, the ultrasonic blade 102 is attached to an underside 210 of the inclined conveyor belt 112 and/or can extend past an end 212 of the inclined conveyor belt 112. The cutting edge of the ultrasonic blade 102 can be a blunt edge or a blunt tip and/or can vibrate at a frequency of 20 kHz or greater. Additionally or alternatively, the cutting edge of the ultrasonic blade 102 can be sharpened and/or honed to a sharp edge and/or be serrated, scalloped or otherwise modified. As such, safety during operation and maintenance of the system 100 can be improved by reducing or eliminating a number of exposed sharp edge blades in the harvesting unit of the system 100.

In some examples, the system 100 can include a computing device for providing control over the various components discussed herein. The computing device can include a non-transitory computer-readable storage storing instructions (e.g., software) that, when executed by one or more processors, causes the system 100 to perform one or more operations discussed herein. For instance, the steps for cutting the plant(s) 106 and/or adjusting the cutting angle or height can be implemented by the computing device. In some instances, the computing device can receive a user input, sensor data (e.g., imaging data), and/or operational data to determine a type of plant, height of the plant, or location of the targeting cutting area on the stem of the plant(s) 106 being conveyed by the infeed conveyor belt 104 into the ultrasonic blade 102. The computing device can send instructions (e.g., via an input/output port) to other components of the system 100 (e.g., the angle adjuster 122) to change the cutting angle and/or height of the ultrasonic blade 102 to correspond to the type of plant 106, height of the plant 106, or location of the targeting cutting area on the stem of the plant plant(s) 106. In some instances, the system 100 detects that the plant(s) 106 are within a predetermined proximity of the ultrasonic blade 102 and adjusts the cutting angle and/or height in response.

Furthermore, the power supply and/or frequency of the ultrasonic blade 102 can be controlled and/or adjusted to provide a predetermined amount of cutting force to cleanly severed the top portion(s) 118 from the rest of the plant(s) 106 so that the top portion(s) 108 of the plant(s) 106 quickly and smoothly transfer onto the inclined conveyor belt 112 without bruising, damaging, or disrupting the flow of the harvesting process.

Accordingly, the system 100 disclosed herein can harvest the top portion(s) 118 of the plant(s) 106 in a highly efficient and effective manner. The various arrangements of the system 100 can cut the plants 106 with greater precision, speed, and overall efficiency than previous techniques. Moreover, the system 100 can be adjustable to particular configurations to match the physiological parameters of the plants 106, so that multiple different types of plants can be harvested efficiently using the same equipment while maintaining consistent effectiveness of the cuts. As such, a yield of the salable portions (e.g., the top portion(s) 118) of the plant(s) 106 can be increased while reducing bruising/damage, reducing labor costs, and increasing the quality of the harvested product.

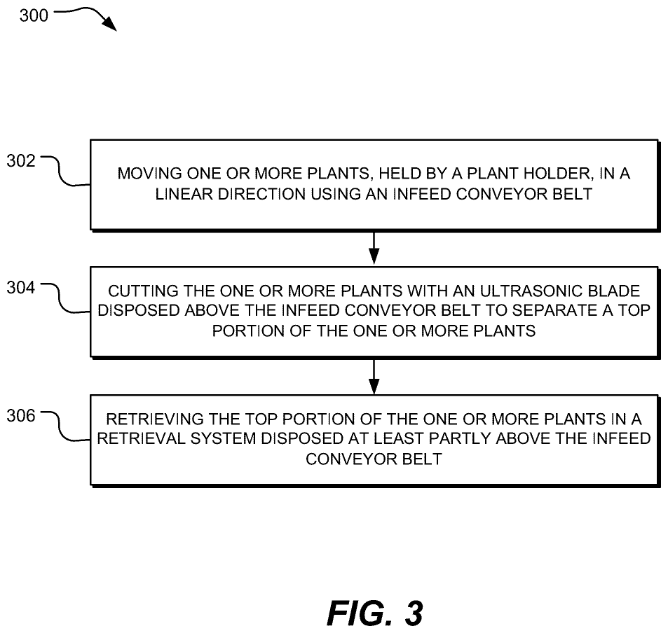

FIG. 3 illustrates an example method 300 for harvesting plants which can be performed by the system 100 depicted in FIG. 1. At operation 302, the method 300 can move one or more plants held by a plant holder in a linear direction using an infeed conveyor belt. At operation 304, the method 300 can cut the one or more plants with an ultrasonic blade disposed above the infeed conveyor belt to separate a top portion of the one or more plants. At operation 306, the method 300 can retrieve the top portion of the one or more plants in a retrieval system disposed at least partly above the infeed conveyor belt.

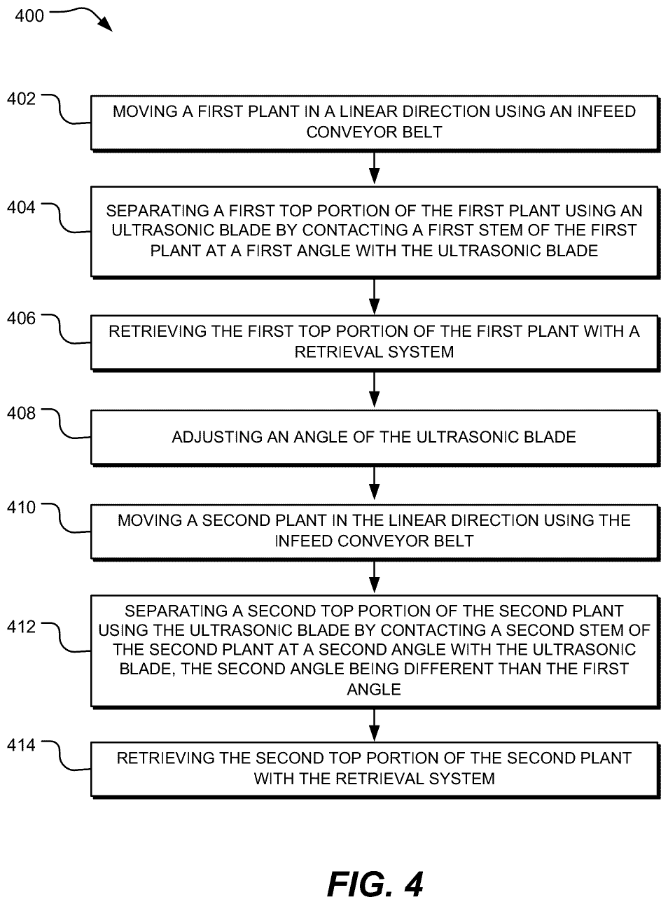

FIG. 4 illustrates an example method 400 for harvesting plants which can be performed by the system 100 depicted in FIG. 1. At operation 402, the method 400 can move a first plant in a linear direction using an infeed conveyor belt. At operation 404, the method 400 can separate a first top portion of the first plant using an ultrasonic blade by contacting a first stem of the first plant at a first angle with the ultrasonic blade. At operation 406, the method 400 can retrieve the first top portion of the first plant with a retrieval system. At operation 408, the method 400 can adjust an angle of the ultrasonic blade. At operation 410, the method 400 can move a second plant in the linear direction using the infeed conveyor belt. At operation 412, the method 400 can separate a second top portion of the second plant using the ultrasonic blade by contacting a second stem of the second plant at a second angle with the ultrasonic blade, the second angle being different than the first angle. At operation 414, the method 400 can retrieve the second top portion of the second plant with the retrieval system.

It is to be understood that the specific order or hierarchy of steps in the method(s) 300 and 400 depicted in FIGS. 3 and 4 and throughout this disclosure are instances of example approaches and can be rearranged while remaining within the disclosed subject matter. For instance, any of the operations depicted in FIGS. 3 and 4 and throughout this disclosure may be omitted, repeated, performed in parallel, performed in a different order, and/or combined with any other of the operations depicted in FIGS. 3 and 4 and throughout this disclosure.

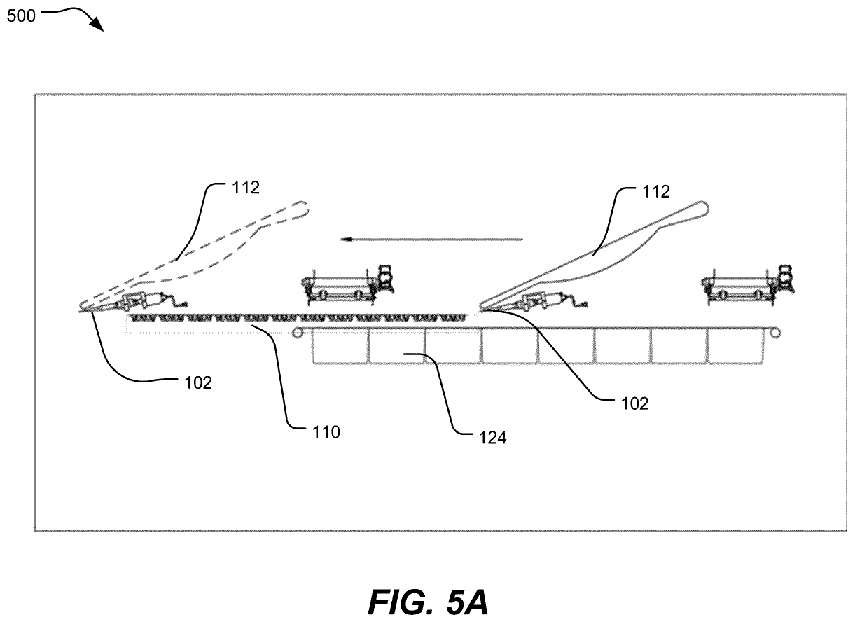

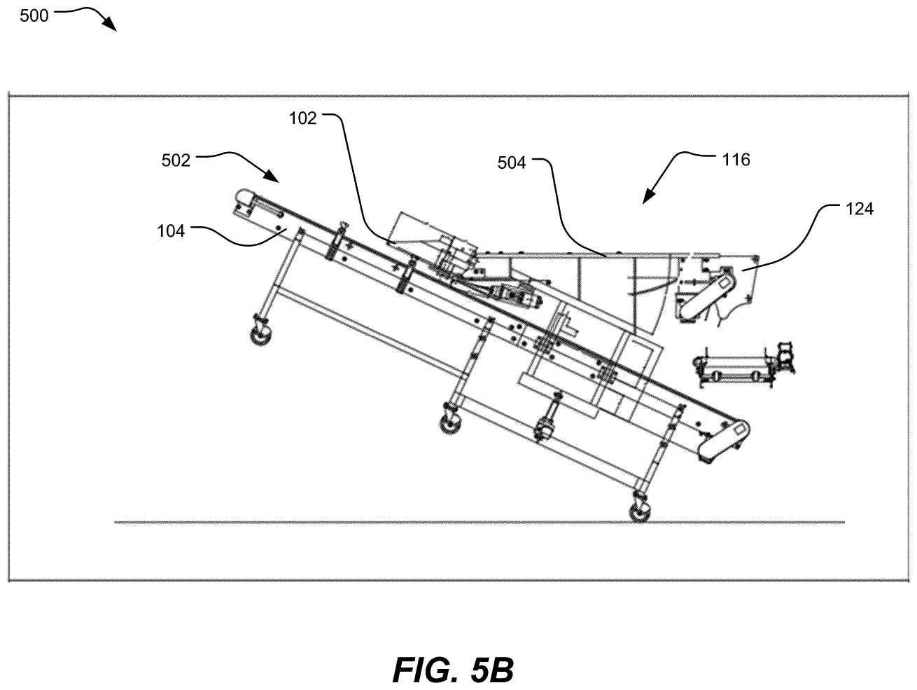

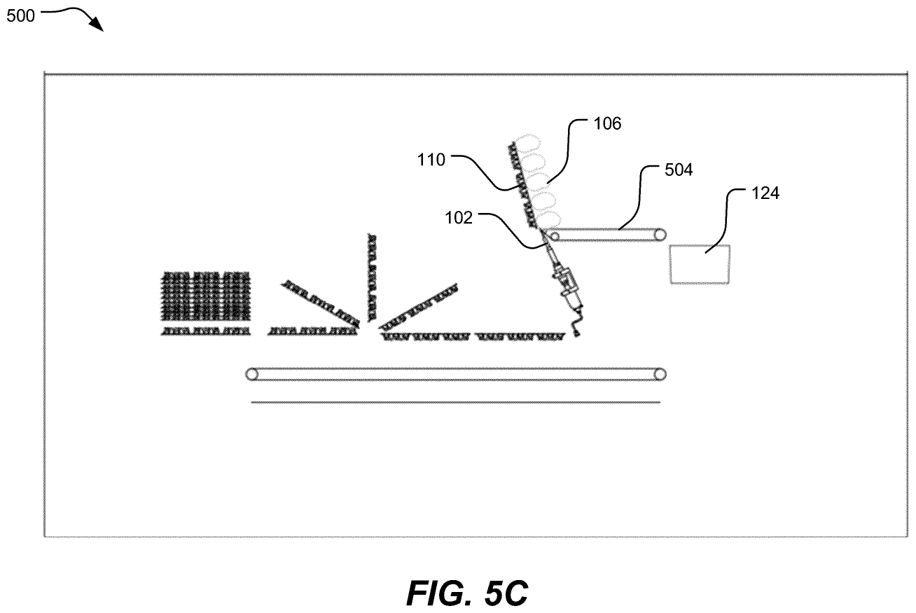

FIGS. 5A-5C illustrate an example system 500 including multiple configurations of the ultrasonic blade 102, the infeed conveyor belt 104, the plant holder 110, and the collection bin(s) 124. The system 500 can form at least a portion off the system 100 depicted in FIG. 1.

In some examples, as shown in FIG. 5A, the rafts and trays in the plant holder 110 can be fixed and the ultrasonic blade 102 and/or portions of the retrieval system 116 can traverse over the rafts and trays during the harvesting process. One or more collection bin 124 can be positioned below the rafts in a fixed position, and can be automatically filled as the top portion(s) 118 waterfall over an edge of the side takeaway conveyor (e.g., the infeed conveyor belt 104).

Furthermore, as shown in FIG. 5B. in some instances, the infeed conveyor belt 104 can be non-horizontal 502, and/or can convey the plant(s) 106 at a declined angle so that a post-cutting conveyor 504 of the retrieval system 116 to retrieve the cut to portion(s) 118 of the plants is at a horizontal plane and/or parallel to the floor.

Turning to FIG. 5C, in some examples, the post cutting conveyor 504 of the retrieval system 116 for retrieving the cut to portion(s) 118 is substantially horizontal and/or parallel to the floor. The plant holder 110 (e.g., rafts) can be fed into the cutting area of the ultrasonic blade 102 in an almost vertical orientation, which can maximize the impact of gravity in the cutting process. This configuration can create space for the post-harvest rafts to be processed and separated from the saleable crops that were cut in the process.

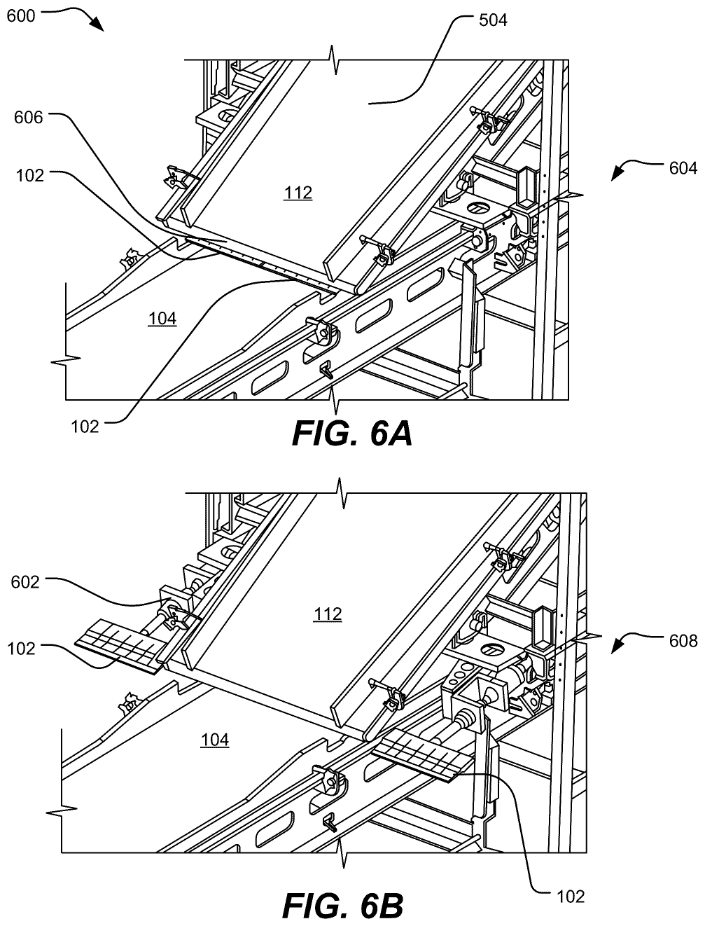

FIGS. 6A and 6B illustrate an example system 600 including the ultrasonic blade 102 mounted in different configurations, which can form at least a portion of the system 600 depicted in FIG. 1.

In some examples, one or more ultrasonic blade 102 are mounted on a linear rail system 602 and can be moved sideways and out from under the inclined conveyor belt 112, for instance, to simplify cleaning and servicing. FIG. 6A depicts the system 100 in an operational configuration 604, with the ultrasonic blade 102 disposed below a receiving edge 606 of the inclined conveyor belt 112. The system 600 can be transitioned from the operational configuration 604 to a maintenance configuration 608, depicted in FIG. 6B, with the ultrasonic blade 102 moved to a side of the inclined conveyor belt 112 out from under the inclined conveyor belt 112. For instance, in scenarios including two ultrasonic blades 102, a first ultrasonic blade 102 can slide out a first side of the inclined conveyor belt 112 and a second ultrasonic blade 102 can slide out a second side of the inclined conveyor belt 112. Upon completing servicing and/or cleaning, the ultrasonic blade(s) 102 can be slid back underneath the inclined conveyor belt 112, returning the system 600 from the 608// back to the operational configuration 604.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A system for harvesting plants including:
a first conveyor surface for moving one or more plants in a linear direction;
an ultrasonic blade disposed above the first conveyor surface at an end of a second conveyor surface of a retrieval system; and
the retrieval system positioned at least partially above the first conveyor surface for receiving a top portion of the one or more plants cut by the ultrasonic blade.

2. The system of claim 1, wherein:
the first conveyor surface is an infeed conveyor belt;
the second conveyor surface is an inclined conveyor belt; and
the retrieval system includes a conveyor mounting frame positioning the inclined conveyor belt above the infeed conveyor belt.

3. The system of claim 2, wherein the conveyor mounting frame includes an angle or height adjuster for adjusting an angle or height of the inclined conveyor belt relative to the infeed conveyor belt.

4. The system of claim 3, wherein the height of the inclined conveyor belt is adjustable between a first height and a second height, the first height corresponding to a first type of the one or more plants and the second height corresponding to a second type of the one or more plants.

5. The system of claim 2, wherein the ultrasonic blade is coupled to an underside of the inclined conveyor belt.

6. The system of claim 2, wherein a blade angle formed by the ultrasonic blade and the infeed conveyor belt is adjustable to correspond to a type or a maturity of the one or more plants.

7. The system of claim 1, wherein the one or more plants include a plurality of edible plants in a growing tray on the first conveyor surface.

8. The system of claim 1, wherein the ultrasonic blade includes a row of ultrasonic blades extending perpendicular to the linear direction in which the one or more plants move.

9. The system of claim 1, wherein a cutting edge of the ultrasonic blade is directed in a third direction that forms an acute angle with a plane defined by the first conveyor surface.

10. The system of claim 1, wherein the ultrasonic blade includes a honed edge that contacts one or more stems of the one or more plants.

11. The system of claim 10, wherein the ultrasonic blade forms a non-perpendicular cutting angle with one or more stems of the one or more plants.

12. A method for harvesting plants including:
moving one or more plants held by a plant holder in a linear direction using an infeed conveyor belt;
cutting the one or more plants with an ultrasonic blade disposed above the infeed conveyor belt to separate a top portion of the one or more plants; and
retrieving the top portion of the one or more plants in a retrieval system disposed at least partly above the infeed conveyor belt.

13. The method of claim 12, further comprising:
moving, using the infeed conveyor belt a bottom portion of the one or more plants cut by the ultrasonic blade underneath the retrieval system.

14. The method of claim 12, wherein retrieving the top portion of the one or more plants includes:
receiving the top portion of the one or more plants on an inclined conveyor belt of the retrieval system positioned above the infeed conveyor belt.

15. The method of claim 14, wherein retrieving the top portion of the one or more plants includes:
dropping the top portion of the one or more plants off an end of the inclined conveyor belt into a collection area including at least one of a collection bin, a hopper, another conveyor belt, or a machine intake.

16. The method of claim 14, wherein retrieving the top portion of the one or more plants includes:
sending the top portion of the one or more plants from the inclined conveyor belt onto a takeaway conveyor belt.

17. The method of claim 12, wherein:
the one or more plants comprise first one or more plants;
cutting the first one or more plants includes contacting the first one or more plants with the ultrasonic blade at a first cutting angle; and
the method further comprises:
adjusting a position of the ultrasonic blade relative to the infeed conveyor belt; and
cutting a second one or more plants by contacting the second one or more plants with the ultrasonic blade at a second cutting angle that is different than the first cutting angle.

18. The method of claim 17, wherein the first cutting angle corresponds to a first height associated with the first one or more plants and the second cutting angle corresponds to a second height associated with the second one or more plants.

19. The method of claim 12, wherein cutting the one or more plants includes severing one or more stems of one or more plants with an edge of the ultrasonic blade vibrating at a frequency of 20 kHz or greater.

20. A method for harvesting plants comprising:
moving a first plant in a linear direction using an infeed conveyor belt;
separating a first top portion of the first plant using an ultrasonic blade by contacting a first portion of the first plant at a first height with the ultrasonic blade;
retrieving the first top portion of the first plant with a retrieval system;
adjusting a height of the ultrasonic blade;
moving a second plant in the linear direction using the infeed conveyor belt;
separating a second top portion of the second plant using the ultrasonic blade by contacting a second portion of the second plant at a second height with the ultrasonic blade, the second height being different than the first height; and
retrieving the second top portion of the second plant with the retrieval system.
